(19) United States
(12) Patent Application Publication
(10) Pub. No.: US 2026/0005268 A1
(43) Pub. Date: Jan. 1, 2026

(54) MAGNETIC ROTOR APPARATUS FOR A SIDE CHANNEL COMPRESSOR FOR A FUEL CELL SYSTEM, SIDE CHANNEL COMPRESSOR, AND A METHOD FOR MANUFACTURING A MAGNETIC ROTOR APPARATUS FOR A SIDE CHANNEL COMPRESSOR FOR A FUEL CELL SYSTEM

(71) Applicant: Robert Bosch GmbH, Stuttgart (DE)

(72) Inventors: Rene Schepp, Waiblingen (DE); Frank Laemmle, Winnenden (DE); Frank Jennewein, Martinshoehe (DE)

(21) Appl. No.: 18/880,721

(22) PCT Filed: Jun. 29, 2023
(86) PCT No.: PCT/EP2023/067781

§ 371 Date: Jan. 2, 2025

(30) Foreign Application Priority Data
Jul. 27, 2022 (DE) 10 2022 207 714.8

(51) Int. Cl. H01M 8/04111; F04D 25/06; H02K 21/24

(52) U.S. Cl. CPC H01M 8/04111; F04D 25/06; H02K 21/24

(57) ABSTRACT

The invention relates to a magnetic rotor apparatus (2) for a side channel compressor (1) for a fuel cell system (31) for conveying and/or compacting a gaseous medium, in particular hydrogen, wherein the magnetic rotor apparatus (2) is supported in such a way that it can be rotated about the axis of rotation (4) and/or can be driven by means of a drive (6). The magnetic rotor apparatus (2) comprises a compressor wheel (10) by means of which a gas flow can be produced, in particular in a compressor space (30), a hub (9), a locking ring (22) and at least one bearing (27, 47). According to the present invention, the hub (9) comprises a recess (13) that extends in an annular fashion around the axis of rotation (4). In this case, the components of the locking ring (22) and at least two segment magnets (24), ideally four segment magnets (24), are located at least almost completely in the recess (13). The invention further relates to a side channel compressor (1) having a magnetic rotor apparatus (2) according to the invention and/or a fuel cell system (31) and/or a method for manufacturing the magnetic rotor apparatus (2).

### BACKGROUND

The present invention relates to a magnetic rotor apparatus for a side channel compressor for a fuel cell system, a side channel compressor, and a method for manufacturing a magnetic rotor apparatus for a side channel compressor for a fuel cell system.

In the automotive sector, in addition to liquid fuels, gaseous fuels will also play an increasing role in the future. In particular in vehicles with fuel cell drive, hydrogen gas flows need to be controlled. The gas flows are no longer controlled discontinuously, as they are with liquid fuel injection; instead the gaseous medium is withdrawn from at least one high-pressure tank and directed to an ejector unit via a supply line of a medium-pressure line system. This ejector unit feeds the gaseous medium to a fuel cell via a connecting line of a low-pressure line system. After the gaseous medium has flowed through the fuel cell, it is fed back to the ejector unit via a return line. The side channel compressor can be interconnected to support the flow and efficiency of gas recirculation. In addition, side channel compressors are used to assist in building up the flow in the fuel cell drive, particularly in case of a (cold) start-up of the vehicle after a certain service life. These side channel compressors are typically powered by electric motors that are supplied with voltage by the vehicle battery when operating in vehicles.

A side channel compressor for a fuel cell system is known from DE 10 2018 222 102 A1, in which a gaseous medium, in particular hydrogen, is conveyed and/or compressed. The side channel compressor comprises a housing and a drive, wherein the housing comprises a housing upper part and a housing lower part, with a compressor space circumferential in the housing about an axis of rotation comprising at least one circumferential side channel, with a compressor wheel located in the housing arranged such that it can be rotated about the axis of rotation and driven by the drive. The compressor wheel comprises blades arranged at its periphery in the area of the compressor space and is equipped with a gas inlet opening formed on the housing and a gas outlet opening that are connected via a fluidic connection through the compressor space, in particular the at least one side channel, wherein the side channel compressor comprises at least one bearing. In addition, it is shown in DE 10 2018 222 102 A1 that a rotor assembly, which can be designed as a permanent magnet, is located on a driver flange corresponding to a hub.

The side channel compressor known from DE 10 2018 222 102 A1 can have certain disadvantages. The rotor assembly and/or the permanent magnet is located on the driver flange and is not encapsulated by a rotor space, in particular the rotor assembly and/or the permanent magnet is not fluidly encapsulated by the rotor space. When the side channel compressor is in use, hydrogen can intrude into the rotor space and damage the metal components and/or the rotor assembly and/or the permanent magnet, in particular through hydrogen embrittlement. In this case, the rotor assembly and/or the permanent magnet may fail, such that the compressor wheel and/or a magnetic rotor apparatus can no longer be driven by means of the drive, in particular by means of a stator and rotor assembly, so that the probability of failure of the drive and thus the entire side channel compressor increases.

A further disadvantage of the side channel compressor known in DE 10 2018 222 102 A1 is that a locking ring and/or the permanent magnet is pressed into the hub, forming an interference fit with the hub, especially with its inner diameter, whereby, a deformation of the hub, in particular a bearing bore and/or a bearing seat, results due to the stresses involved, that such that the bearing bore and/or bearing seat need to be remachined, which increases costs due to the additional process step.

### SUMMARY

The invention provides for a magnetic rotor apparatus for a side channel compressor for a fuel cell system for conveying and/or compacting a gaseous medium, in particular hydrogen. The magnetic rotor apparatus is at least almost entirely enclosed in a rotor space and is supported by a rotation axis in such a manner that it can be rotated, and/or can be driven by means of a drive. The magnetic rotor apparatus comprises a compressor wheel by means of which a gas flow can be produced in particular in a compressor space, a hub, a locking ring and at least one bearing.

The hub comprises an annular recess which extends around the rotation axis and which can be encapsulated by the rotor space, wherein the components of the locking ring and at least two segment magnets, ideally four segment magnets, are located at least almost completely in the recess.

This makes it possible to achieve multiple advantages. On the one hand, it allows for a compact and space-saving arrangement and design for the magnetic rotor apparatus, because the components of the locking ring and segment magnet can be integrated in the recess and thus in the hub, whereby the magnetic rotor apparatus is narrower in the direction of the rotational axis compared to the magnetic rotor apparatus from the prior art.

On the other hand, this also makes it possible to achieve the advantage that the components of the locking ring and the segment magnet can be encapsulated by the rotor space. Thus, it is possible to at least nearly completely prevent hydrogen originating from the area of the compressor space from intruding into the area of the rotor space and damaging the components of the locking ring and segment magnet, which in particular prevents damage to these components by hydrogen embrittlement. Therefore, the likelihood of failure of the magnetic rotor apparatus and/or the engine and/or the side channel compressor may be reduced, thereby increasing the service life of the magnetic rotor apparatus and/or the engine and/or the side channel compressor.

According to one advantageous embodiment of the magnetic rotor apparatus, the locking ring is connected to the hub by means of at least one screw connection. This makes it possible to achieve the advantage that the locking ring can be connected to the hub in a cost-efficient manner, and that the connection can also be released once again, for example for maintenance measures. The hub and/or the locking ring are not damaged during disassembly. The probability of failure of the bearings can also be improved, since a bearing bore, in particular the tolerances of a bearing seat, is at least nearly unaltered in the inner diameter of the hub by the screw fitting, in contrast to the locking ring, which is pressed into the hub. This results in increased service life of the bearings and/or hub and/or the magnetic rotor apparatus and/or the side channel compressor. In addition, screwing the locking ring to the hub prevents an additional method step, because the bearing bore and/or the bearing seat do not have to be remachined with the locking ring pressed into the hub, which in particular forms an interference fit, in particular via a grinding process.

According to an advantageous further development of the magnetic rotor apparatus, the recess is limited orthogonally to the rotational axis on its side facing away from the rotational axis via a circumferential cylindrical collar and on its side facing the rotational axis via a circumferential cylindrical shoulder to the hub in each case. In this way, a compact design can be achieved for the magnetic rotor apparatus, thereby reducing the size of the entire side channel compressor. This in turn may reduce the required installation space for the side channel compressor in the overall vehicle. In addition, efficient encapsulation of the locking ring and/or the respective segment magnet by the rotor space can be achieved by means of the cylindrical shoulder and/or collar. The encapsulation can prevent the locking ring and/or segment magnet components from being damaged by components of the gaseous medium, for example by hydrogen embrittlement due to the hydrogen contained in the gaseous medium. Thus, the service life of the magnetic rotor apparatus and/or the side channel compressor may be increased and the probability of failure may be reduced.

According to a particularly advantageous embodiment of the magnetic rotor apparatus, the recess is opened on its side facing the stator, in particular in the direction of the axis of rotation. This allows for simple and cost-efficient assembly of the locking ring and/or the segment magnet in the hub, in particular in the direction of the rotational axis. Assembly costs and/or maintenance costs may be reduced, thereby reducing the manufacturing costs and/or operating costs of the magnetic rotor apparatus and thus also the side channel compressor. Furthermore, this allows for a compact design of the magnetic rotor apparatus and the hub.

According to an advantageous embodiment of the magnetic rotor apparatus, the recess opened towards the stator is closed and/or encapsulated by means of a cover plate. In this way, inexpensive and efficient encapsulation of the recess and the components located in the recess, in particular the locking ring and the respective segment magnet, can be achieved. In so doing, water and/or hydrogen from the rotor space can be prevented from entering the area of the recess and damaging the components located in said recess, for example by hydrogen embrittlement and/or by oxidation. Thus, the likelihood of failure of the magnetic rotor apparatus and/or the side channel compressor may be reduced, wherein the service life of the side channel compressor may be increased and/or improved.

According to an advantageous further development of the magnetic rotor apparatus, the locking ring comprises bars facing the rotation axis, wherein a segment magnet is located in each intermediate space between two bars. In this way, it is possible to achieve the advantage that when the respective segment magnet is exposed to a force by means of the drive, the resulting torque is transmitted, in particular due to a positive connection between the segment magnet and the locking ring, in a reliable manner and almost free from loss, such that the magnetic rotor apparatus and/or the entire compressor wheel can be reliably driven and/or placed in rotational motion by means of the drive. In addition, a compact and narrow design of the components of the locking ring and the respective segment magnet is possible, because the segment magnet can be at least partially accommodated and installed in the locking ring. In this way, the magnetic rotor apparatus and the side channel compressor may be designed more narrow.

According to a particularly advantageous further development of the magnetic rotor apparatus, the cylindrical shoulder of the hub has a first external thread and the locking ring has a first internal thread. A first screw connection is formed by a positive locking and/or a force locking of the first external thread with the first internal thread. This makes it possible to achieve the advantage of a reliable connection between the locking ring and the hub. This connection can be established quickly and in a cost-effective manner during assembly, wherein the connection can be detached without being destroyed in the event of damage to the locking ring and/or the respective segment magnet, so that the corresponding damaged components can be replaced quickly and in a cost-effective manner. Thus, the service life of the magnetic rotor apparatus and/or the side channel compressor may be increased.

According to an advantageous embodiment of the magnetic rotor apparatus, the cylindrical collar of the hub has a second internal thread and the locking ring has a second external thread. A second screw connection is formed by means of a positive locking and/or a force locking connection of the second external thread with the second internal thread. This makes it possible to achieve the advantage of a reliable connection between the locking ring and the hub. This connection can be established quickly and in a cost-effective manner during assembly, wherein the connection can be detached without being destroyed in the event of damage to the locking ring and/or the respective segment magnet, so that the corresponding damaged components can be replaced quickly and in a cost-effective manner. Thus, the service life of the magnetic rotor apparatus and/or the side channel compressor may be increased, wherein the ease of servicing the magnetic rotor apparatus is also improved. In addition, the second screw connection in the hub is not in the direct vicinity of the bearing bore, so that there is no interference with the play of the bearing or any tolerances between the hub and the respective bearing, in particular if the locking ring is screwed into the bearing. Thus, the likelihood of failure of the bearings can be reduced because the bearing bore is at least nearly free from deformity after assembly of the locking ring.

As the preferred scope of application of the magnetic rotor apparatus according to the present invention is a side channel compressor and/or a fuel cell system, a side channel compressor and/or a fuel cell system is further proposed with the magnetic rotor apparatus according to the present invention.

In accordance with an advantageous embodiment in the proposed method for manufacturing the magnetic rotor apparatus for a side channel compressor and/or a fuel cell system. The locking ring is provided, wherein the locking ring comprises at least two bars, which in particular run in the direction of the axis of rotation, and a segment magnet is attached between each set of two bars. Then the respective segment magnet is connected to the locking ring, in particular an end face of the locking ring and/or to the respective bars. This connection may be completed by means of a positive locking and/or a material locking and/or a friction locking method for forming a rotor assembly. This rotor assembly is then installed in the compressor wheel and fixed by way of at least one screw.

In a particularly advantageous embodiment of the method, it is suggested that the cover plate be attached to the collar and the shoulder by means of a material-locking method, in particular laser welding.

The invention is not limited to the exemplary embodiments described herein and the aspects highlighted thereby. Rather, within the range specified by the claims, a plurality of modifications is possible, which lie within the abilities of a skilled person.

### BRIEF DESCRIPTION OF THE DRAWINGS

The invention is described in greater detail below with reference to the drawings.

Shown are:

FIG. 1 a schematic sectional view of a side channel compressor according to the invention,

FIG. 2 a schematic sectional view of a magnetic rotor apparatus with a compressor wheel, a hub, a locking ring and at least one bearing,

FIG. 3 a top perspective view of the hub according to the invention according to an exemplary embodiment with the locking ring with four bars and four respective segment magnets,

FIG. 4 a perspective sectional view of a rotor assembly according to the invention,

FIG. 5 a sectional view of the rotor assembly according to the invention pursuant to the prior art,

FIG. 6 a schematic sectional view of the magnetic rotor apparatus according to a first exemplary embodiment,

FIG. 7 a schematic sectional view of the magnetic rotor apparatus according to a second exemplary embodiment.

### DETAILED DESCRIPTION

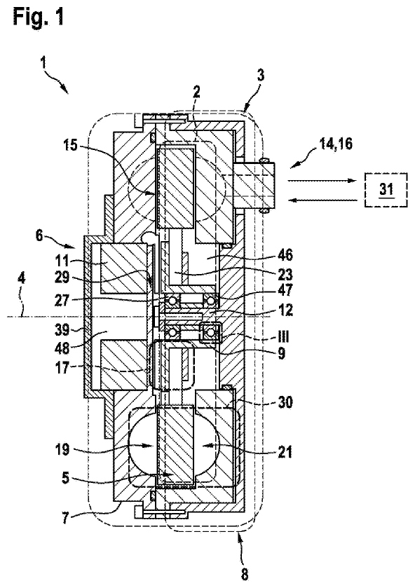

The illustration according to FIG. 1 shows a schematic sectional view of a side channel compressor 1 according to the invention.

It is shown in FIG. 1 that the side channel compressor 1 for a fuel cell system 31 is provided with a housing 3 and a drive 6 for conveying and/or compacting a gaseous medium, in particular hydrogen, wherein the housing 3 comprises a housing upper part 7 and a housing lower part 8. In addition, the housing 3 comprises a compressor space 30 extending circumferentially around an axis of rotation 4, which comprises at least one circumferential side channel 19, 21, with a magnetic rotor apparatus 2 located in the housing 3, which is arranged in such a manner that it can be rotated about the axis of rotation 4 and which is driven by the drive 6, wherein the magnetic rotor apparatus 2 comprises blades 5 arranged at its circumference in the area of the compressor space 30, each having a gas inlet opening 14 formed on the housing 3 and a gas outlet opening 16, which are connected to one another via a fluidic connection through the compressor space 30, in particular the at least one side channel 19, 21, wherein the side channel compressor 1 comprises at least one bearing 27, 47. The at least one side channel 19, 21 can extend circumferentially around the axis of rotation 4 at least in a sub-area of the housing 3, wherein an interruption area 15 is configured in the housing 3 in the sub-area in which the at least one side channel 19, 21 is not configured in the housing 3.

It is also shown in FIG. 1 that the drive 6 is designed as an axial field electric motor 6 having a stator 11 and a rotor assembly 17, wherein the stator 11 and the rotor assembly 17 are formed disc-shaped and circumferentially around the rotational axis 4 and wherein the stator 11 is arranged in the direction of the rotational axis 4 adjacent to the rotor assembly 17. The rotor assembly 17 can be located at least indirectly on or in a hub disk 23 of the magnetic rotor apparatus 2. In addition, it is shown in FIG. 1 that the side channel compressor 1 has a stator space 48 and a rotor space 46, wherein at least some of the components of the drive 6 are arranged in these spaces 46, 48. The housing upper part 7 comprises a continuous wall 29, which is located between the stator space 48 and the rotor space 46 and causes a fluidic separation of these two spaces. The stator space 48 is also at least partially surrounded and/or encapsulated by a stator housing 39. The housing lower part 8 comprises a cylindrical bearing pin 12, wherein the bearing pin 12 extends in the direction of the axis of rotation 4, such that its lateral surface extends circumferentially around the axis of rotation 4, and wherein a first bearing 27 and/or a second bearing 47 are radially contacting the axis of rotation 4 with the lateral surface of the bearing pin 12. The drive 6 can be embodied as an axial field electric motor 6 comprising a stator 11 and the rotor assembly 17, wherein the stator 11 is arranged in the direction of the axis of rotation 4 adjacent to the rotor assembly 17. In addition, the side channel compressor 1 comprises the cylindrical bearing pin 12, wherein the bearing pin 12 extends in the direction of the axis of rotation 4, such that its lateral surface extends circumferentially around the axis of rotation 4. The first bearing 27 and/or the second bearing 47 are in contact with the lateral surface of the bearing pin 12 radially to the axis of rotation 4.

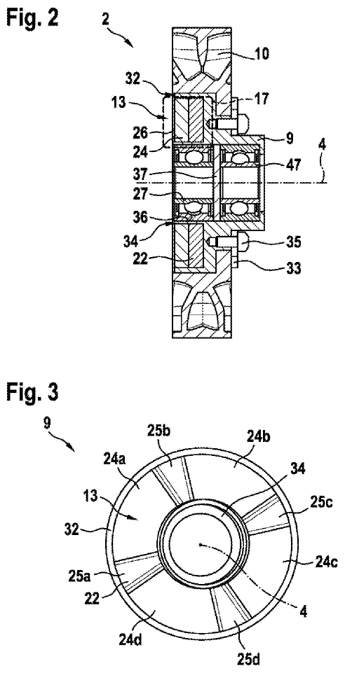

In FIG. 2 a schematic sectional view of the magnetic rotor apparatus 2 with a compressor wheel 10, a hub 9, a locking ring 22 and at least one bearing 27, 47 is shown. The magnetic rotor apparatus 2 shown is a component of the side channel compressor 1 for the fuel cell system 31 for conveying and/or compacting a gaseous medium, in particular hydrogen. The magnetic rotor apparatus 2 can be located at least nearly entirely in the rotor space 46 and can be supported such that it can be rotated about the axis of rotation 4 and can be driven by means of the drive 6. The magnetic rotor apparatus 2 comprises the compressor wheel 10, by means of which a gas flow can be generated, in particular in the compressor space 30. Furthermore, the magnetic rotor apparatus 2 comprises the hub 9, the locking ring 22 and at least one bearing 27, 47.

Furthermore, FIG. 2 shows that the hub 9 comprises a recess 13 extending around the rotation axis 4 in an annular fashion which can be encapsulated by the rotor space 46, wherein the components of the locking ring 22 and at least two segment magnets 24, ideally four segment magnets 24, are located almost completely in the recess 13. However, in further exemplary embodiments, six segment magnets 24 or more may also be located in the recess 13. A spacer 37 may be located between the first bearing 27 and the second bearing 47 in the direction of the axis of rotation 4, wherein a distance between the bearings 27, 47 can be adjusted by means of the spacer 37.

As shown in FIG. 2, the rotor assembly 17 is connected to a compressor wheel 10 by means of at least one spring washer 33 and at least one screw 35. The recess 13 extends orthogonally disc-shaped to the axis of rotation 4 and is limited on its side facing away from the axis of rotation 4 by the circumferential cylindrical collar 32 of the hub and on its side facing the axis of rotation 4 via a circumferential cylindrical shoulder 34 of the hub 9. The hub 9 forms the cylindrical collar 32 at its outer diameter facing away from the axis of rotation 4 and the cylindrical shoulder 34 at its inner diameter facing the axis of rotation 4. Within the inner diameter and/or cylindrical shoulder 34, there is also a bearing bore 36 having a bearing seat 45.

FIG. 2 shows that the recess 13 is open on its side facing the stator 11 (shown in FIG. 1), in particular in the direction of the axis of rotation 4. In an exemplary embodiment of the side channel compressor 1, the recess 13 is open towards the stator 11, wherein the recess 13 can be closed and/or encapsulated by means of a cover plate 26. The cover plate 26 is attached to an end face of the hub 9 facing the stator 11, wherein the cover plate 26 is non-magnetic and can be attached to the hub 9 by means of at least one laser welding process. The hub 9 and/or the locking ring 22 and/or the segment magnets 24 and/or the spring washer 33 and/or the screw 35 form the rotor assembly 17.

The magnetic rotor apparatus 2 shown in FIG. 2 may comprise a variety of materials. In one exemplary embodiment of the magnetic rotor apparatus 2, the hub 9 may comprise an austenitic stainless steel, in particular X2CrNiMo17-12-2 (1.4404), the locking ring 22 may comprise an unalloyed structural steel, in particular S235JR and/or St37 and/or St52, and/or a magnetic machining steel, in particular 11SMn30. For example, the segment magnets may comprise NdFeB and the cover plate 26 may comprise austenitic stainless steel, in particular X2CrNiMo17-12-2 (1.4404). In addition, the compressor wheel 10, which can comprise aluminum and/or plastic and has a stepped profile, is pushed onto the hub 9 in the direction of the axis of rotation 4 before the components hub 9 and the compressor wheel 10 come into contact with the shoulders of their stepped profile and are then screwed using the at least one spring washer 33 and the at least one screw 35.

After this mounting step, the magnetic rotor apparatus 2 may be balanced in an exemplary embodiment to keep the centrifugal forces low during operation. In this case, material is taken away at defined areas of the compressor wheel 10 and/or the hub 9. Finally, after balancing, the bearings 27, 47 and spacer 37 are pressed in across the outer diameter. In an alternative embodiment, the balancing may also be carried out as a final manufacturing step.

FIG. 3 shows a top perspective view of the hub 9 according to the invention pursuant to an exemplary embodiment with the locking ring 22 having four bars 25 and four respective segment magnets 24. It is shown that the hub 9 has the shoulder 34 circumferential about the axis of rotation 4 at its inner diameter facing the axis of rotation 4 and that the hub 9 has the collar 34 circumferential about the axis of rotation 4 at its outer diameter facing away from the axis of rotation 4. First, the locking ring 22 is inserted into the recess 13 of the hub 9, in particular, wherein the locking ring 22 in this exemplary embodiment of the magnetic rotor apparatus 2 comprises a first bar 25a, second bar 25b, third bar 25c and fourth bar 25d, which extend particularly in the direction of the rotational axis 4. In alternative embodiments, the locking ring 22 may comprise at least two bars 25 or a plurality of bars 25. Here, one segment magnet 24 respectively is placed in each space between two bars 25 circumferentially about the axis of rotation 4. In this exemplary embodiment of the magnetic rotor apparatus 2, it comprises a first segment magnet 24a, a second segment magnet 24b, a third segment magnet 24c and a fourth segment magnet 24d.

Two opposing segment magnets 24 are each configured as a north pole and two opposing segment magnets as a south pole, so that on a circular track, one segment magnet 24 always alternates as the north pole and south pole on a circular path that extends circumferentially around the rotation axis 4. These segment magnets configured as circular segments may represent an even number of segment magnets 24 that can be magnetized, which are placed on one side of the hub 9. The bars 25 are present between the circle segments 24, which can separate the segment magnets 24 from one another laterally (in the radial revolution). In the magnetic rotor apparatus 2, the segment magnets 24 must be fixed in order to transfer the torque of the drive 6 as well as an optional axial magnetic force. This function is assumed by the locking ring 22 permanently connected to the hub 9.

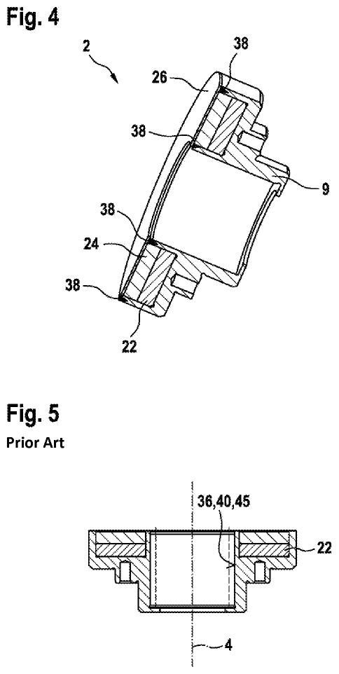

FIG. 4 shows a perspective sectional view of the rotor assembly 17 according to the invention including the cover plate 26. In this case, it is shown that the cover plate 26 in this exemplary embodiment of the magnetic rotor apparatus 2 is attached to the collar 32 (shown in FIG. 2) and to the shoulder 34 by means of a material-locking method, in particular laser welding, in such a way that a encapsulation of the recess 13 (shown in FIG. 2), in particular a fluid encapsulation takes place. The respective laser weld seam 38 in the collar 32 and/or in the shoulder 34 can consist of a plurality of dotted laser welds 38 around the axis of rotation 4 (shown in FIG. 2), with the pins extending tapering from the cover plate 26 into the hub 9. However, it can also be a respective weld seam in the collar 32 and/or in the shoulder 34 that extends in an annular fashion around the rotation axis 4.

FIG. 5 shows a schematic sectional view of the rotor assembly 17 according to the invention (shown in FIG. 2) pursuant to the prior art. The locking ring 22 is pressed into the hub 9 in the area of the surface 40 (shown in FIG. 2). This pressing causes the bearing bore 36 to deform. Subsequent assembly of the respective bearings 27, 47 (shown in FIG. 2), which are in particular ball bearings 27, 47, may be very difficult to achieve due to the deformation in the area of the surface 40 and may damage the bearings 27, 47 in advance, so that the probability of failure of the bearings 27, 47 and thus the entire side channel compressor 1 is increased.

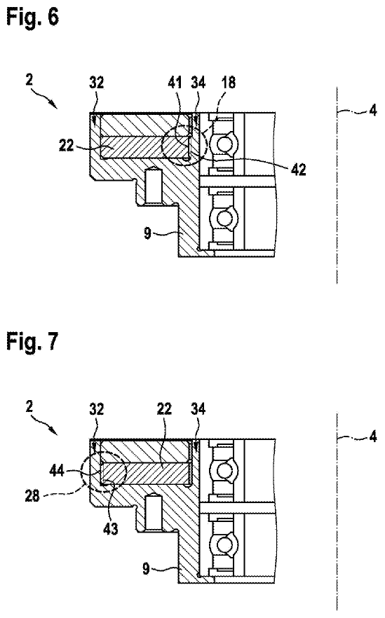

In FIG. 6, a schematic sectional view of the rotor apparatus 2 according to a first exemplary embodiment is shown. Here, the cylindrical shoulder 34 of the hub 9 comprises a first external thread 41 and the locking ring 22 comprises a first internal thread 42, wherein a first screw connection 18 is formed by a positive locking and/or a force locking of the first external thread 41 with the first internal thread 42. For the purpose of a possible manufacturing process and/or method for manufacturing the magnetic rotor apparatus 2 for the side channel compressor 1 and/or the fuel cell system 31 (shown in FIG. 1), the following steps can be carried out to form the magnetic rotor apparatus 2:
providing the locking ring 22, wherein the locking ring 22 comprises at least two bars 25, and wherein it is possible to attach a segment magnet 24 between each set of two bars,
installing the locking ring 22 in the recess 13, wherein the locking ring 22 is connected to the hub 9 by means of at least one screw fitting 18, 28,
connecting the respective segment magnet 24 to the locking ring 22, in particular to an end face of the locking ring 22 and/or to the respective bars 25, by way of a positive-locking, material-locking, or force-locking method for forming the rotor assembly 17.

As shown in FIG. 6, attachment of the locking ring 22 may be completed by means of the first fitting 18 without deforming the bearing bore 36 of the hub 9. The bearing bore 36 serves as the bearing seat and therefore has very narrow tolerance requirements. The hub 9 is made of a relatively soft, non-magnetic, weldable, austenitic stainless steel. This and the very low wall thickness in the area of the circumferential cylindrical shoulder 34 is the reason that the bearing bore 36 can deform in the prior art shown in FIG. 5 for the pressed-in locking ring 22 having a high stiffness. Thus, by means of the configuration of the magnetic rotor apparatus 2 according to the invention with the screwed-in locking ring 22, deformation of the bearing bore 36 can be prevented, which, when the respective bearing 27, 47 is pressed in, leads to a greatly reduced bearing play, which would negatively affect the bearing life due to the temperature variations (specifically at low temperatures). Thus, due to the design of the magnetic rotor apparatus 2 according to the invention, after the assembly of the rotor assembly 17, no extensive regrinding of the bearing bore 36 is required. The aim is to design a connection that does not deform the bearing bore 36 after assembly and does not require the bearing bore 36 to be ground out later. The lock ring 22 transfers the torque of the drive 6 to the compressor wheel 10 and must also withstand the axial force of the stator 11. This screw fitting 18 prevents deformations in the bearing seat and/or the bearing bore 36. Due to a suitable tightening torque, the fitting 18, 28 can transmit the required axial force and torque. Advantages include an increase in the life of the bearings 27, 47, easier and less expensive manufacturing of the magnetic rotor apparatus 2, since expensive grinding processes are omitted.

FIG. 7 shows a schematic sectional view of the magnetic rotor apparatus 2 according to a second exemplary embodiment. The cylindrical collar 32 of the hub 9 comprises a second internal thread 43 and the locking ring 22 comprises a second external thread 44, wherein a second screw connection 28 is formed by a positive fit and/or a force fit of the second external thread 44 with the second internal thread 43. The same advantages result by means of the second screw connection 28 as with the first screw connection 18, as already described in FIG. 6.

1. A magnetic rotor apparatus (2) for a side channel compressor (1) for a fuel cell system (31) for conveying and/or compacting a gaseous medium, wherein the magnetic rotor apparatus (2) is supported in such a manner that it can be rotated about an axis of rotation (4) and/or can be driven by a drive (6), wherein the magnetic rotor apparatus (2) comprises a compressor wheel (10), which can be used to generate a gas flow, a hub (9), a locking ring (22) and at least one bearing (27, 47), wherein the hub (9) comprises an annular recess (13) extending around the axis of rotation (4) and encapsulating from a rotor space (46), wherein components of the locking ring (22) and at least two segment magnets (24), are located almost completely in the recess (13).

2. The magnetic rotor apparatus (2) according to claim 1, wherein the locking ring (22) is connected to the hub (9) by at least one screw connection (18, 28).

3. The magnetic rotor apparatus (2) according to claim 1, wherein the recess (13) is limited orthogonally to the axis of rotation (4) on a side facing away from the axis of rotation (4) via a circumferential cylindrical collar (32) and on a side facing the axis of rotation (4) via a circumferential cylindrical shoulder (34) of the hub (9).

4. The magnetic rotor apparatus (2) according to claim 1, wherein the recess (13) is open on a side facing the stator (11).

5. The magnetic rotor apparatus (2) according to claim 1, wherein the recess (13) opened towards the stator (11) is closed and/or encapsulated by a cover plate (26).

6. The magnetic rotor apparatus (2) according to claim 1, wherein the locking ring (22) comprises bars (25) facing towards the axis of rotation (4), wherein a segment magnet (24) is located in respective intermediate spaces between two bars (25).

7. The magnetic rotor apparatus (2) according to claim 3, wherein the cylindrical shoulder (34) of the hub (9) comprises a first outer thread (41) and the locking ring (22) comprises a first inner thread (42), wherein a first screw connection (18) is formed by a positive locking and/or a force locking of the first outer thread (41) with the first inner thread (42).

8. The magnetic rotor apparatus (2) according to claim 3, wherein the cylindrical collar (32) of the hub (9) comprises a second internal thread (43), and the locking ring (22) comprises a second external thread (44), wherein a second screw connection (28) is formed by a positive fit and/or a force fit of the second external thread (44) with the second internal thread (43).

9. A side channel compressor (1) with a stator (11) and a magnetic rotor apparatus (2) according to claim 1.

10. A fuel cell system (31) having a side channel compressor (1) according to claim 9, wherein the side channel compressor (1) is disposed in an anode circuit of the fuel cell system (31).

11. A method for manufacturing a magnetic rotor apparatus (2) for a side channel compressor (1) and/or a fuel cell system (31) according to claim 1, the method comprising:
providing the locking ring (22), wherein the locking ring (22) comprises at least two bars (25), and wherein it is possible to attach a segment magnet (24) between each set of two bars,
installation of the locking ring (22) in the recess (13) of the hub (9), wherein the locking ring (22) is connected to the hub (9) by at least one screw fitting (18, 28),
connecting the respective segment magnet (24) to the locking ring (22), by way of a positive-locking, material-locking, or force-locking method for forming the rotor assembly (17).

12. The method according to claim 11, wherein a cover plate (26) is attached to a collar (32) and to a shoulder (34) by a material-locking method.

13. The magnetic rotor apparatus (2) according to claim 1, wherein the gaseous medium is hydrogen.

14. The magnetic rotor apparatus (2) according to claim 1, wherein the compressor wheel (10) generates the gas flow in a compressor space (30).

15. The magnetic rotor apparatus (2) according to claim 1, wherein four segment magnets (24) are located almost completely in the recess (13).

16. The method according to claim 11, wherein connecting the respective segment magnet (24) to the locking ring (22 includes connecting the respective magnet (24) to an end face of the locking ring (22) and/or to the respective bars (25).

17. The method according to claim 12, wherein the cover plate (26) is attached to the collar (32) and to the shoulder (34) by laser welding.
